(19) United States
(12) Patent Application Publication
(10) Pub. No.: US 2016/0204544 A1
(43) Pub. Date: Jul. 14, 2016

(54) Self-Aligning and Self-Engaging Electrical Connectors

(71) Applicant: Blackrock Microsystems, LLC., Salt Lake City, UT (US)

(72) Inventors: ShaoNung Liang, Salt Lake City, UT (US); Mike Sorenson, Salt Lake City, UT (US); Michael Gruenhagen, Salt Lake City, UT (US); Stephen R. Irwin, Ogden, UT (US)

(21) Appl. No.: 14/592,060

(22) Filed: Jan. 8, 2015

(51) Int. Cl. H01R 13/62

(52) U.S. Cl. CPC H01R 13/6205

(57) ABSTRACT

Systems and methods for making and using an electrical connector system for electrically connecting an implantable medical device and a data acquisition system are described. The electrical connector system includes a base connected to the implantable medical device and an adaptor connected to the data acquisition system. The base includes a plurality of base magnets arranged on a base contact surface in a unique non-symmetrical pattern. The base contact surface also includes a plurality of base electrical contacts. The adaptor has an adaptor contact surface with a plurality of adaptor magnets and adaptor electrical contacts configured to match those of the base contact surface. The unique non-symmetrical pattern allows the base contact surface and the adaptor contact surface to self-align and self-engage to electrically connect the implantable medical device and the data acquisition system. Other embodiments are described.

### FIELD

This application relates generally to electrical connectors. More specifically, this application relates to self-aligning and self-engaging electrical connectors that are configured to connect implantable medical devices and data acquisition systems.

### BACKGROUND

Neurological studies of a test subject can involve a sensor, a connector, and a data acquisition system. The sensor detects neurological activity and transmits it through a connector to a data acquisition system. A researcher then uses the data acquisition system to analyze the neurological activity of the test subject. In one type of neurological study, the sensor is in the form of an implantable medical device that is implanted into the brain of a test subject, often a laboratory animal. An electrical connector is used to transmit detected neurological activity from the implanted medical device in the form of electrical signals to the data acquisition system.

During neurological studies, it can be challenging for the researcher to attach the connector to the implanted medical device of the laboratory animal in order to begin a test. The laboratory animal is frequently mobile and attaching the connector requires restraining the animal sufficiently to first align both halves of the connector and then engage both halves of the connector to complete the electrical connection. This can lead to frustration on the part of the researcher and can stress the laboratory animal. This problem is often compounded by the fact that the researcher is wearing gloves and/or other protective gear that reduces the researcher's dexterity and makes aligning and engaging both halves of the connector even more challenging. Additionally, once the connector is engaged, there is the possibility that the laboratory animal will exert excessive force on the connector and the attached tether. This can lead to injury to the laboratory animal and/or to damage or dislocation of the implanted medical device.

### SUMMARY

This application describes self-aligning and self-engaging electrical connectors for connecting implantable medical devices with data acquisition systems. This application also describes systems containing such self-aligning and self-engaging electrical connectors, and methods of using such electrical connectors. The self-aligning and self-engaging electrical connector includes a base that is electrically connected to the implantable medical device. The base includes a base contact surface with a plurality of base magnets arranged on a base contact surface. The plurality of magnets are arranged to form a unique non-symmetrical pattern. The base also includes a plurality of base electrical contacts arranged on the base contact surface and a base interface configured to electrically connect the plurality of base electrical contacts to the implantable medical device. The self-aligning and self-engaging electrical connector also includes an adaptor that is connected to the data processing unit. The adaptor includes an adaptor contact surface that is configured to mate with the base contact surface. The adaptor contact surface has a plurality of adaptor magnets arranged on the adaptor contact surface. The adaptor magnets are arranged such that the polarities of the plurality of adaptor magnets mirror the unique non-symmetrical pattern of the base magnets. The adaptor also includes a plurality of adaptor electrical contacts arranged on the adaptor contact surface with the adaptor contacts arranged to mate with the base electrical contacts. The adaptor also includes an adaptor interface configured to electrically connect the plurality of adaptor electrical contacts to the data acquisition system. The unique non-symmetrical pattern allows the base contact surface and the adaptor contact surface to self-align when in close proximity. The plurality of magnets allows for the base and adaptor to self-engage and for the implantable medical device and the data acquisition system to be connected.

Additionally, in some implementations, the self-aligning and self-engaging electrical connector system includes an implantable medical device, an electrical processing unit, a base, and an adaptor. The base is electrically connected to the implantable medical device and includes a base contact surface with a plurality of base magnets arranged on a base contact surface. The plurality of magnets are arranged to form a unique non-symmetrical pattern. The base also includes a plurality of base electrical contacts arranged on the base contact surface with one or more of the base magnets configured as base electrical contacts. The base also includes a base interface configured to electrically connect the plurality of base electrical contacts to the implantable medical device. The adaptor is connected to the data processing unit and includes an adaptor contact surface that is configured to mate with the base contact surface. The adaptor contact surface has a plurality of adaptor magnets arranged on the adaptor contact surface. The adaptor magnets are arranged such that the polarities of the plurality of adaptor magnets mirror the unique non-symmetrical pattern of the base magnets. The adaptor also includes a plurality of adaptor electrical contacts arranged on the adaptor contact surface with the adaptor contacts arranged to mate with the base electrical contacts. One or more of the adaptor magnets is further configured as adaptor electrical contacts. The adaptor also includes an adaptor interface configured to electrically connect the plurality of adaptor electrical contacts to the data acquisition system. The unique non-symmetrical pattern allows the base contact surface and the adaptor contact surface to self-align when in close proximity. The plurality of magnets allows for the base and adaptor to self-engage and for the system to connect the implantable medical device and the data acquisition system.

Furthermore, in some implementations, this application describes methods for connecting an implantable medical device and a data acquisition system using a self-aligning and self-engaging electrical connector system. The method includes implanting an implantable medical device in a test subject, providing a data acquisition system, providing a base, providing an adaptor and connecting the base and the adaptor to connect the implantable medical device and the data acquisition system. The base is electrically connected to the implantable medical device and includes a base contact surface with a plurality of base magnets arranged on a base contact surface. The plurality of magnets are arranged to form a unique non-symmetrical pattern. The base also includes a plurality of base electrical contacts arranged on the base contact surface with one or more of the base magnets configured as base electrical contacts. The base also includes a base interface configured to electrically connect the plurality of base electrical contacts to the implantable medical device. The adaptor is connected to the data processing unit and includes an adaptor contact surface that is configured to mate with the base contact surface. The adaptor contact surface has a plurality of adaptor magnets arranged on the adaptor contact surface. The adaptor magnets are arranged such that the polarities of the plurality of adaptor magnets mirror the unique non-symmetrical pattern of the base magnets. The adaptor also includes a plurality of adaptor electrical contacts arranged on the adaptor contact surface with the adaptor contacts arranged to mate with the base electrical contacts. One or more of the adaptor magnets is further configured as adaptor electrical contacts. The adaptor also includes an adaptor interface configured to electrically connect the plurality of adaptor electrical contacts to the data acquisition system. The adaptor and the base are connected by bringing the base contact surface and the adaptor contact surface into close proximity allowing the base contact surface and the adaptor contact surface to self-align and to self-engage to connect the implantable medical device and the data acquisition system.

Moreover, in some implementations, this application describes a connection system that can comprise a first connector containing first connecting elements with both positive and negative polarities, a second connector containing second connecting elements configured to match with the first connection elements, with each second connecting element having a polarity opposite the matching first connecting element and a slip compensation feature located between the first and second connectors and configured to reduce or prevent a variable contact spacing between first connecting elements and second connecting elements along the z-axis, with the first or second connector containing a geometrical feature configured to retain the slip compensation feature. In some embodiments, one or more of the first or second connecting elements can comprise magnets. In other embodiments, the magnets can comprise transition metals, rare-earth elements, lanthanide elements and combinations thereof. In yet other embodiments, one or more of the first connecting elements or second connecting elements can be raised relative to the first connector or second connector with one or more matching second connecting elements or first connecting elements being recessed relative to the first connector or the second connector, and with one or more raised first connecting elements or second connecting elements being configured to mate with the one or more matching second connecting elements or first connecting elements. In some embodiments, one or more of the first connecting elements can be disposed within a recess in the first connector, with the first connecting element further comprising a conductive wire configured to bias the first connecting element along the z-axis to overcome the variable contact spacing. In another embodiment, the slip compensating feature can further comprise an anisotropically conductive membrane disposed between the first connector and the second connector, with the anisotropically conductive membrane configured to deform to overcome the variable contact spacing. In yet another embodiment, the system can further comprise a breakaway configuration configured to disengage the first connector and the second connector when a threshold of force is applied to either the first connector or the second connector. In some embodiments, one or more of the first or second connecting elements can comprise magnets and the threshold of force can be adjusted between a minimum and maximum threshold by decreasing or increasing a total of magnets used. In other embodiments, the system can further comprise an implantable medical device electrically connected to the first connector and a data acquisition system electrically connected to the second connector.

Lastly, in some implementations, this application describes kits for electrically connecting an implantable medical device and a data acquisition system. The kit includes a base and an adaptor. The base is electrically connected to the implantable medical device and includes a base contact surface with a plurality of base magnets arranged on a base contact surface. The plurality of magnets are arranged to form a unique non-symmetrical pattern. The base also includes a plurality of base electrical contacts arranged on the base contact surface with one or more of the base magnets configured as base electrical contacts. The base also includes a base interface configured to electrically connect the plurality of base electrical contacts to the implantable medical device. The adaptor is connected to the data processing unit and includes an adaptor contact surface that is configured to mate with the base contact surface. The adaptor contact surface has a plurality of adaptor magnets arranged on the adaptor contact surface. The adaptor magnets are arranged such that the polarities of the plurality of adaptor magnets mirror the unique non-symmetrical pattern of the base magnets. The adaptor also includes a plurality of adaptor electrical contacts arranged on the adaptor contact surface with the adaptor contacts arranged to mate with the base electrical contacts. One or more of the adaptor magnets is further configured as adaptor electrical contacts. The adaptor also includes an adaptor interface configured to electrically connect the plurality of adaptor electrical contacts to the data acquisition system. The unique non-symmetrical pattern allows the base contact surface and the adaptor contact surface to self-align when in close proximity. The plurality of magnets allows for the base and adaptor to self-engage and for the system to connect the implantable medical device and the data acquisition system.

### BRIEF DESCRIPTION OF THE DRAWINGS

The following description can be better understood in light of the Figures, in which:

FIG. 1 shows a perspective view of a self-aligning self-engaging electrical connector;

FIGS. 2A to 2N illustrate detailed views of the base and the adaptor;

FIG. 3 illustrates a system for connecting an implantable medical device with a data acquisition system using a self-aligning self-engaging electrical connector; and

FIG. 4 illustrates a method for connecting an implantable medical device with a data acquisition system using a self-aligning self-engaging electrical connector.

The Figures illustrate specific aspects of the electrical connectors and systems containing them. Together with the following description, the Figures demonstrate and explain the principles of the methods and structures. In the drawings, the thickness of layers and regions are exaggerated for clarity. The same reference numerals in different drawings represent the same element, and thus their descriptions will not be repeated. As the terms on, attached to, or coupled to are used herein, one object (e.g., a material, a layer, a substrate, etc.) can be on, attached to, or coupled to another object regardless of whether the one object is directly on, attached, or coupled to the other object or there are one or more intervening objects between the one object and the other object. Also, directions (e.g., above, below, top, bottom, side, up, down, under, over, upper, lower, horizontal, vertical, “x,” “y,” “z,” etc.), if provided, are relative and provided solely by way of example and for ease of illustration and discussion and not by way of limitation. In addition, where reference is made to a list of elements (e.g., elements a, b, c), such reference is intended to include any one of the listed elements by itself, any combination of less than all of the listed elements, and/or a combination of all of the listed elements.

### DETAILED DESCRIPTION

The following description supplies specific details in order to provide a thorough understanding. Nevertheless, the skilled artisan will understand that the described self-aligning and self-engaging electrical connectors and associated methods of making and using the devices can be implemented and used without employing these specific details. Indeed, the self-aligning and self-engaging electrical connectors and associated methods can be placed into practice by modifying the described devices and methods and can be used in conjunction with any other apparatus and techniques conventionally used in the industry. For example, while the description below focuses on methods for making and using the self-aligning and self-engaging electrical connectors for connecting implantable medical devices with data acquisition systems, they can be used with virtually any other type of electrical connections including consumer electronics, electrical connections requiring a safe disconnection feature after an established threshold force has been exceeded, electrical connections in low light conditions, electrical connections in low hand dexterity conditions, and electrical connections to improve accessibility for persons with disabilities.

The electrical connectors comprise any suitable component to connect an implantable medical device with a data acquisition system. In the illustrated embodiments, one half of the connector is connected to an implantable medical device and the other half of the connector is attached to a data acquisition system.

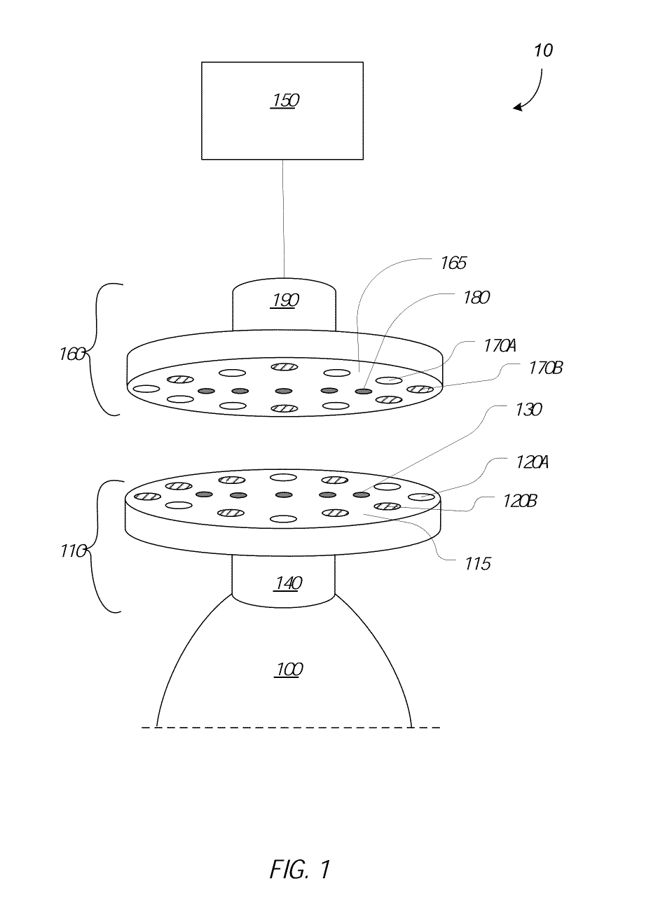

FIG. 1 illustrates some embodiments of the electrical connector 10. In FIG. 1, the electrical connector 10 connects an implantable medical device 100 to a data acquisition system 150. The connector 10 comprises a base 110 that can be attached or connected to the implantable medical device 100. The base 110 includes a base contact surface 115 and base magnets 120A and 120B. The base magnets 120A and 120B can be arranged on the base contact surface 115 such that the polarities of the base magnets 120A and 120B form a unique non-symmetrical pattern. In some configurations, the base magnets 120A can be arranged such that the magnetic north polarities are exposed on the base contact surface 115. The base magnets 120B can also be arranged such that the magnetic south polarities are exposed on the base contact surface 115. As described in more detail below, in some embodiments, base magnets 120A and 120B can be further configured as electrical contacts.

The base 110 further comprises a plurality of base electrical contacts 130. The base electrical contacts 130 can be arranged on the base contact surface 115 with any desired configuration. In some embodiments, the base electrical contacts 130 can be arranged on the base contact surface 115 to ensure proper alignment of the electrical connector 10. The base 110 also comprises a base interface 140 that can be configured to electrically connect the base electrical contacts 130 to the implantable medical device 100.

As shown in FIG. 1, the electrical connector 10 further comprises an adaptor 160 that is attached or connected to the data acquisition system 150. The adaptor 160 comprises an adaptor contact surface 165 that can be configured to mate with the base contact surface 115. The adaptor 160 also comprises adaptor magnets 170A, 170B. The adaptor magnets 170A, 170B can be arranged on the adaptor contact surface 165 such that the polarities of the plurality of adaptor magnets 170A, 170B mirror the unique non-symmetrical pattern of the base magnets 120A, 120B. In the embodiments depicted in FIG. 1, the adaptor magnets 170A can be arranged such that the north polarities are exposed on the adaptor contact surface 165. Adaptor magnets 170B can also be arranged such that the south polarities are exposed on the adaptor contact surface 165. As described in more detail below, in some embodiments, adaptor magnets 170A and 170B can be further configured as electrical contacts.

In some configurations, the adaptor magnets 170A, 170B can be arranged such that their polarities mirror those of the base magnets 120A, 120B when the base contact surface 115 and the adaptor contact surface 165 are attached or connected to each other. For example, the magnetic north polarity of a base magnet 120A can be paired with the magnetic south polarity of an adaptor magnet 170B. Likewise, the magnetic south polarity of a base magnet 120B can be paired with the magnetic north polarity of an adaptor magnet 170A. In this fashion, a base magnet 120A is magnetically attracted to an adaptor magnet 170B and a base magnet 120B is magnetically attracted to an adaptor magnet 170A. Similarly, a base magnet 120A is magnetically repulsed by an adaptor magnet 170A and a base magnet 120B is magnetically repulsed by an adaptor magnet 170B.

The polarities of the magnets 120A, 120B, 170A, 170B can be arranged in any non-symmetrical pattern such that there is only one orientation in which the base 110 and the adaptor 160 can mate that is consistent with all of the magnetic attractions between the respective magnets 120A, 120B, 170A, and 170B. In the event of a potential misalignment of the base 110 and the adaptor 160 as they are brought into close proximity, the respective magnetic attractions and magnetic repulsions allow the base 110 and the adaptor 160 to self-align with respect to each other. Due to the non-symmetrical pattern of the polarities of the magnets, the base 110 and the adaptor 160 can self-align in the x, y, and z axes and also through a rotational theta axis, allowing the base 110 and adaptor 160 to self-align. Once the base 110 and adaptor 160 have self-aligned, the magnetic attraction of the paired polarities of the magnets 120A, 120B, 170A, 170B draws the base 110 and the adaptor 160 together to mate the base contact surface 115 and the adaptor contact surface 165 to self-engage the connector 10.

As depicted in FIG. 1, the adaptor 160 further comprises adaptor electrical contacts 180. The adaptor electrical contacts 180 can be arranged on the adaptor contact surface 165 to mate with the base electrical contacts 130. When the base 110 and the adaptor 160 mate, the base electrical contacts 130 contact the adaptor electrical contacts 180 such that individual electrical connections are established between the base electrical contacts 130 and the adaptor electrical contacts 180. Each individual base electrical contact 130 can be assured to establish an electrical connection with its respective partner adaptor electrical contact 180 because the base 110 and adaptor 160 self-align and self-engage. As described in more detail below, in some embodiments, electrical contacts 130 and 180 can be further configured as magnets.

The adaptor 160 further comprises an adaptor interface 190 that can be configured to electrically connect the adaptor electrical contacts 180 with the data processing unit 150. This connection can be made using any electrical connection.

In some configurations, the contact surfaces of the base 110 and the adaptor 160 can be configured to engage and align with each other. Accordingly, these contact surfaces can have any desired geometric shape, recessing, and/or male/female connections to improve alignment and engagement. As described in greater detail below, in other embodiments, the contact surfaces of the base 110 and the adaptor 160 can be configured to allow for a break away configuration that allows for disconnection of the electrical connector 10 when a certain threshold of force is applied.

In some embodiments, the base magnets 120 and the adaptor magnets 170 can comprise strong, permanent magnets comprising transition metals, alloys of rare earth elements and/or lanthanide elements. The magnets can include neodymium magnets and samarium-cobalt magnets. The magnets can include magnets comprising Nd₂Fe₁₄B, Nd₂Fe₁₄B, SmCo₅, and/or Sm(Co,Fe,Cu,Zr)₇. In some cases, the magnets can comprise a rare earth magnet that is plated or coated to improve electrical conductivity. In other cases, the magnets can comprise a rare earth magnet that is plated or coated to improve biocompatibility. In other embodiments, the magnets can comprise ferrous magnets or alnico magnets. In yet other embodiments, the magnets can comprise ferrous based magnets, alnico based magnets and rare earth magnets. In some embodiments, the magnets can comprise electromagnets. In other embodiments, the magnets can comprise electromagenet comprising a ferromagnetic core.

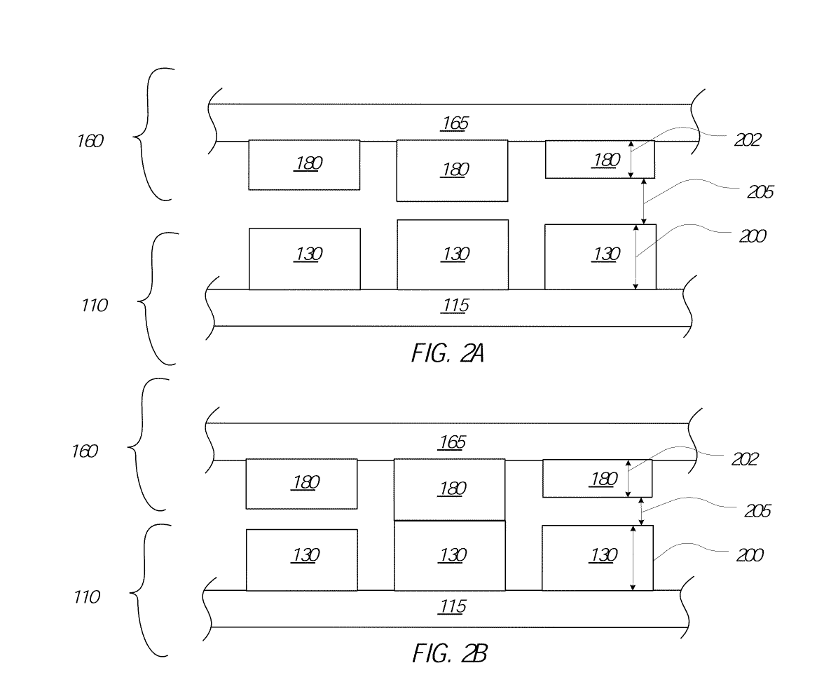

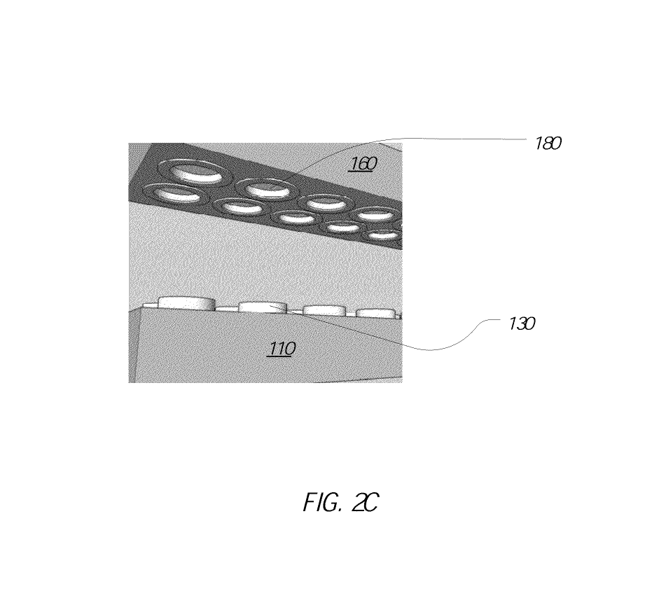

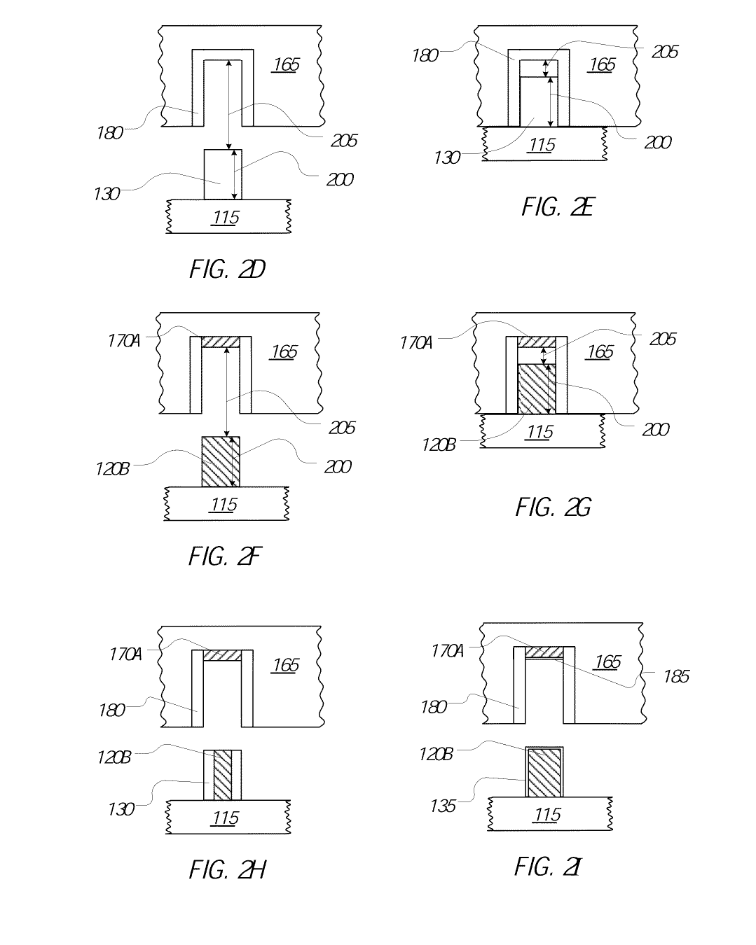

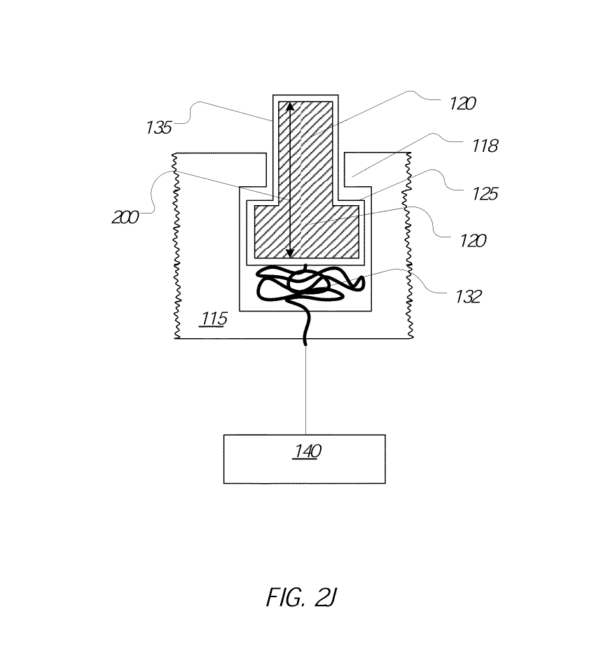

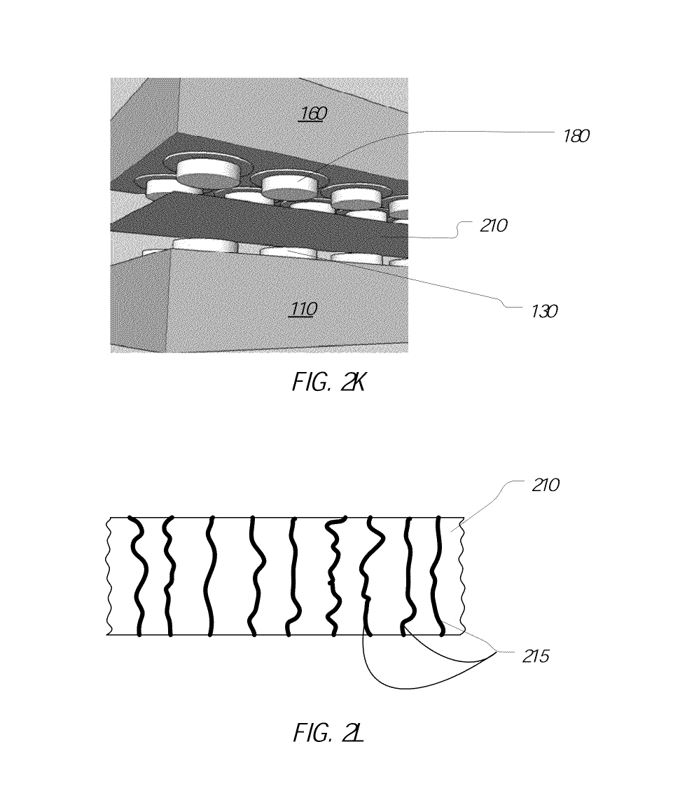

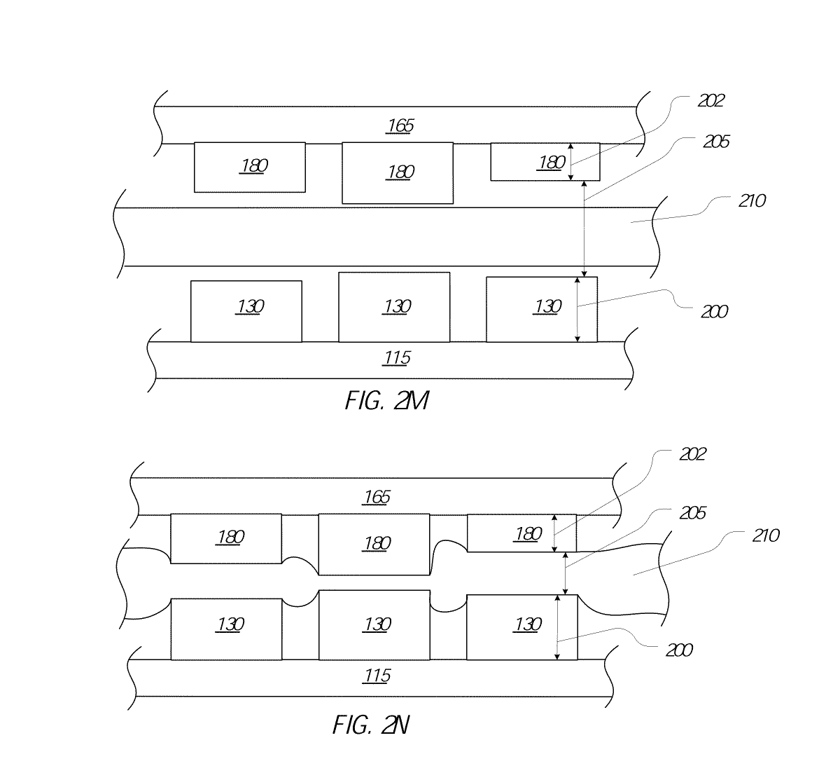

FIGS. 2A and 2B illustrate side views of some embodiments of the base 110 and the adaptor 160. In FIG. 2A, the base 110 and adaptor 160 can be configured in close proximity and aligned in the x-axis and y-axis, but not engaged along the z-axis. The base electrical contacts 130 and the adaptor electrical contacts 180 are illustrated in relation to the base contact surface 115 and the adaptor contact surface 165, respectively. Each individual base electrical contact 130 has an individual base electrical contact height 200 that varies slightly due to the limits of manufacturability. Similarly, each individual adaptor electrical contact 160 has an individual adaptor electrical contact height 202 that also varies slightly due to the limits of manufacturability. This variability in the base electrical contact height 200 and adaptor electrical contact height 202 leads to a variable contact spacing 205 between the base electrical contact 130 and the adaptor electrical contacts 180.

In FIG. 2B, the base 110 and the adaptor 160 can be configured to be aligned in the x and y axes and engaged along the z-axis. FIG. 2B illustrates that the variability in heights 200 and 202 allows some pairs of base electrical contacts 110 and adaptor electrical contacts 160 to make direct contact. FIG. 2B also illustrates that the variability in heights 200, 202 prevents some pairs of base electrical contacts 130 and adaptor electrical contacts 180 from making direct contact. In the base electrical contact and adaptor electrical contact pairs in which the variability in heights 200 and 202 prevent direct contact, there remains a variable contact spacing 205 along the z-axis. In these pairs with a remaining variable contact spacing 205, there can be no electrical connection or a poor electrical connection with low or intermittent continuity. Any remaining variable contact spacing(s) 205 between individual contact pairs 130, 180, can prevent the electrical connector 10 from functioning or cause the electrical connector 10 to function poorly.

FIGS. 2A and 2B are not drawn to scale and certain features have been exaggerated to illustrate the variability in heights 200, 202 and to illustrate the variable contact spacing 205. For embodiments of larger scale connectors 10 with base and adaptor electrical contacts 130, 180 on the order of several millimeters or more in diameter and/or height, the variability in heights 200, 202 and the resulting variable contact spacing(s) 205 are less helpful to the function of the electrical connector 10. In these embodiments, conventional manufacturing processes can create components of sufficient uniformity such that the variability in heights 200, 202 and the resulting variable contact spacings 205 are within acceptable tolerances and less likely to affect the function of these electrical connectors 10. For other embodiments in which the overall electrical connector 10 is reduced in size with base and adaptor electrical contacts 130, 180 on the order of 500 μm, 250 μm, 100 μm, or 10 μm in diameter, or similar sizes, the variability in heights 200, 202 and the resulting variable contact spacings 205 are more likely to affect the function of the electrical connector 10. In some embodiments, the variability in heights 200, 202 and the resulting variable contact spacings 205 can be brought within acceptable tolerances by more stringent manufacturing and quality control processes. As the manufacturing and quality control processes become more stringent the cost of manufacturing likely increases. Manufacturing time also likely increase. As the size of the electrical contacts 130, 180 are reduced, even more stringent manufacturing and quality control processes are needed to bring the variability in heights 200, 202 and the resulting variable contact spacings 205 within acceptable tolerances and cost and time consequently increase.

FIG. 2C illustrates embodiments of the electrical connector 10 that contains a z-axis slip compensating feature (or z-slip compensating feature). In FIG. 2C, the base electrical contacts 130 or the adaptor electrical contacts 180 can be raised from the contact surface 115, 165 and the counterpart electrical contacts can be recessed into the contact surface 115, 165. The base magnets 120 and adaptor magnets 170 can also be similarly raised and recessed. This raised and recessed configuration improves the engagement of the connector 10 and also provides slip compensation along the z-axis. The slip compensation feature can improve the alignment and engagement of the base 110 and the adaptor 160. The slip compensation feature also overcomes the variability in heights 200, 202 and overcomes the resulting variable contact spacings 205. While FIG. 2C illustrates the base 110 with the raised contacts and the adaptor 160 with the recessed contacts, the base 110 can comprise recessed contacts and the adaptor 160 can comprise raised contacts. In yet other embodiments, base 110 can have both raised contacts and recessed contacts and adaptor 160 can comprise matching counterpart raised and recessed contacts.

FIGS. 2D to 2J illustrate other embodiments of z-axis slip compensating feature(s). The z-axis slip compensating feature for the electrical contacts can allow the base electrical contact 130 and the adaptor electrical contact 180 to directly contact along the raised and recessed surfaces despite any resulting variable contact spacing 205. As well, the raised and recessed z-axis slip compensating features can overcome any resulting variable contact spacing 205 and any variability in the height 200 by allowing the electrical connector 10 to engage along the z-axis while enabling an electrical connection between the base electrical contact 130 and the adaptor electrical contact 180. The z-axis slip compensating features can also be used for magnets can function in similar fashion by allowing base magnets 120 to engage adaptor magnets 170 despite any resulting variable contact spacing 205.

FIGS. 2D and 2E illustrate other embodiments of z-axis slip compensating features for electrical contacts. FIGS. 2D and 2E show cross-sectional views of a raised base electrical contact 130 and a recessed adaptor electrical contact 180. The raised base electrical contact 130 and the recessed adaptor electrical contact 180 can be configured such that the height 200 of the base electrical contact 130 approximates the depth of the recessed adaptor electrical contact 180. FIG. 2E illustrates embodiments with the electrical connector 10 engaged along the z-axis. The raised base electrical contact 130 mates within the recessed adaptor electrical contact 180 as the contact surfaces 115, 165 are brought into close proximity. The height 200 of the raised base electrical contact 130 and the corresponding depth of the recessing of the adaptor electrical contact are configured such that, within the tolerances of manufacturing the corresponding components, the height 200 approximates the recessing of the adaptor electrical contact 180 to minimize the variable contact spacing 205. Depending on the manufacturing parameters and/or tolerances for the base electrical contact 130 and the adaptor electrical contact 180, the estimated variable contact spacing 205 may also be helpful in determining the required depth of the recessing. The raised and recessed configuration also allows for some slip compensation in the x and y axes as well to overcome variability in the diameters of the base electrical contact 130 and the adaptor electrical contact 180 due to variability in manufacturing.

FIGS. 2F and 2G show cross-sectional views of other embodiments of a z-slip compensating feature for magnets. The raised base magnet 120B and the recessed magnet 170A are configured such that the height 200 of the base magnet 120B can be about the same as the depth of the recessed adaptor magnet 170A. FIG. 2G illustrates embodiments with the electrical connector 10 engaged along the z-axis. The raised base magnet 120B mates within the recessed adaptor magnet 170A as the contact surfaces 115, 165 are brought into close proximity. The height 200 of the base magnet 120B can be about the same as the recessing in the recessed adaptor magnet 170A. Depending on the stringency of manufacturing the base magnet 120B and the adaptor magnet 170A, a variable contact spacing 205 may exist. The raised and recessed z-slip feature can overcome any resulting variable contact spacing 205 and any variability in the height 200 by allowing the base magnet 120B and the adaptor magnet 170A to engage along the z-axis thereby engaging the electrical connector 10. The z-slip compensating feature can allow the base magnet 120B and the adaptor magnet 170A to mate directly through magnetic attraction despite any resulting variable contact spacing 205.

The height 200 of the raised base magnet 120B and the corresponding depth of the recessing of the adaptor magnet 170A can be configured such that, within the tolerances of manufacturing the corresponding components, the height 200 can approximate the recessing of the adaptor magnet 170A to minimize the variable contact spacing 205. The raised and recessed configuration can also allow for some slip compensation in the x and y axes as well to overcome variability in the diameters of the base magnet 120B and the adaptor magnet 170A due to variability in manufacturing. In these embodiments, the adaptor magnet 170A can be configured at the most recessed portion of the recessing. In other embodiments, though, the recessed adaptor magnet 170A can be configured to line all of the inner surfaces of the recessing. In yet other embodiments, the recessed adaptor magnet 170A can be configured to line only a portion of the inner surfaces of the recessing.

FIGS. 2H, 2I, and 2J illustrate embodiments of electrical contacts 130, 180 and magnets 120,170 that can be configured as an integrated unit. These integrated unit configurations can also comprise the z-axis slip compensating features and can be combined with raised and recessed configurations. For example, these integrated units of electrical contacts 130, 180 and magnets 120, 170 can be configured with both base contacts 120, 130 and adaptor contacts 170, 180 in a raised configuration. In another example, these integrated units of electrical contacts 130, 180 and magnets 120, 170 can be configured with both base contacts 120, 130 and adaptor contacts 170, 180 in a planar configuration with the contact surfaces 115, 165 making direct contact.

FIG. 2H illustrates the embodiments of electrical contacts 130, 180 and magnets 120, 170 that can be configured as an integrated unit with z-slip compensating features. The base electrical contact 130 can be configured such that the raised base magnet 120B is disposed as a core within the raised base electrical contact 130. The recessed adaptor electrical contact 180 can be configured to receive the raised base electrical contact 130 such that the recessed adaptor magnet 170A attracts the base magnet 120B and the base electrical contact 130 directly contacts the adaptor electrical contact 180. In some configurations, the base electrical contact 130 can be configured as a core within the raised base magnet 120B. In other configurations, the recessed adaptor magnet 170A may line the recessing and the adaptor electrical contact 180 can be configured at the most recessed portion of the recessing. In yet other configurations, the base magnet 120B and the base electrical contact 130 can be configured in a side-by-side arrangement.

FIG. 2I illustrates embodiments of electrical contacts 130, 180 and magnets 120, 170 that can be configured as an integrated unit and that contain a z-slip compensating feature. The base magnet 120B can be configured as the base electrical contact 130. The adaptor magnet 170A can be configured as the adaptor electrical contact 180. The combination adaptor magnet 170A and adaptor electrical contact 180 can be configured to receive the combination base magnet 120B and base electrical contact 130 such that the recessed adaptor magnet 170A attracts the base magnet 120B and the base electrical contact 130 directly contacts the adaptor electrical contact 180. In some configurations, the recessed adaptor electrical contact 180 can line the recessing and the adaptor magnet 170A can be configured at the most recessed portion of the recessing.

In some embodiments, a conductive coating 135 can be used in the electric connector 10. Thus, the combination base magnet 120B and base electrical contact 130 can be configured with a conductive coating 135. As well, the combination adaptor magnet 170A and adaptor electrical contact 180 can be configured with a conductive coating 185. The conductive coating 135 may comprise a conductive metal such as gold, tin, platinum, silver, metal alloy of nickel and titanium (nitinol), surgical steel, nickel, non-corroding metals, and/or metal alloys. The conductive coating 135 may also comprise a biocompatible material such as gold, conductive plastic, silver, metal alloy of nickel and titanium (nitinol), surgical steel, nickel, non-corroding metals, and/or metal alloys.

FIG. 2J illustrates embodiments of a base magnet 120B and a base electrical contact 130 configured as an integrated unit and further comprising a z-slip compensating feature. The combination base magnet 120B and base electrical contact 130 can be configured such that a portion is disposed within a recessing of the base contact surface 115. The portion that is not disposed within the recessing of the base contact surface 115 can be configured to engage with a combination adaptor magnet 170A and adaptor electrical contact 180. The combination base magnet 120B and base electrical contact 130 can be configured to freely move within a range of motion along the z-axis. The recessing of the base contact surface 115 is also configured with an overhanging rim 118 configured to interact with a corresponding protruding rim 125 on the base magnet 120 to limit the range of motion along the z-axis and to retain the base magnet 120 within the recessing. In some embodiments, the height 200 of the base magnet 120 and the interaction of the overhanging rim 118 and the protruding rim 125 are configured to adjust the range of motion along the z-axis of the combination base magnet 120B and base electrical contact 130. This range of motion along the z-axis can be adjusted to minimize the variable contact spacing 205 and to adjust for variability in manufacturing of the corresponding components. In other embodiments, the diameter of the base magnet 120 is about 250 μm and the length of the base magnet 120 is about 1775 μm.

In other embodiments, the combination base magnet 120B and base electrical contact 130 can also be configured to have some range of motion along the x and y axes. The relative size and/or shape of the base magnet 120 and the recessing can be configured to adjust this range of motion along the x and y axes. The size and/or shape and the interaction of the overhanging rim 118 and the protruding rim 125 can be configured to adjust this range of motion along the x and y axes. This range of motion along the x and y axes can be adjusted to minimize the variable contact spacing 205 and to adjust for variability in manufacturing of the corresponding components. In some configurations, the combination base magnet 120 and base electrical contact 130 can be configured with conductive coating 135. As well, the combination adaptor magnet 170A and adaptor electrical contact 180 can configured with a conductive coating 185 which can be substantially similar to conductive coating 135.

As depicted in FIG. 2J, the combination base magnet 120 and base electrical contact 130 can be configured to be electrically connected to the base interface 140 with a conductive wire 132. The conductive wire 132 comprises a conductive metal such as gold, tin, platinum, silver, metal alloy of nickel and titanium (nitinol), surgical steel, nickel, non-corroding metals, and/or metal alloys. The conductive wire 132 can also be a biocompatible material such as gold, conductive plastic, silver, metal alloy of nickel and titanium (nitinol), surgical steel, nickel, non-corroding metals, and/or metal alloys. In some configurations, the conductive wire 132 is configured to partially fill a void between the base magnet 120 and the recess such that the conductive wire 132 biases the base magnet 120 along the z-axis and away from the recess. In other configurations, a spring element can acts to bias the the base magnet 120 along the z-axis and away from the recess. In yet other configurations, a wrinkled or crumpled conductive metal foil (such as gold foil) can be configured to partially fill the void between the base magnet 120 and the recess such that the crumpled gold foil biases the base magnet 120 along the z-axis and away from the recess. The crumpled gold foil can bias the base magnet 120 along the z-axis and away from the recess and can be configured to electrically connect the combination base magnet 120 and base electrical contact 130 with the base interface 140. In other embodiments, the overhanging rim 118 and the protruding rim 125 can be eliminated and the conductive wire 132 or conductive metal foil can be configured to limit the range of motion along the z-axis of the base magnet 120.

FIGS. 2K to 2N illustrate example embodiments of z-axis slip compensating features that utilizes a conductive membrane 210. In FIG. 2K, the base contacts 130 and the adaptor contacts are configured to be raised from the respective contact surfaces 115, 165. The z-axis slip compensating feature comprises a conducting film membrane 210 interleaved between the base contacts 130 and the adaptor contacts 180. The conducting film membrane 210 provides a slip feature along the z-axis by deforming to overcome the variable contact spacing 205 and by allowing the base contacts 130 and the adaptor contacts 180 to electrically connect.

FIG. 2L illustrates a cross-section view of the conductive membrane 210. In these embodiments, the conducting membrane 210 comprises a silicone material with gold (or other conductive material) threads 215 that are embedded within the silicone material in an anisotropic arrangement. The gold threads 215 are configured such that they are anisotropically oriented along the thinnest dimension of the membrane 210 and are substantially perpendicular with a planar surface of the membrane 210. The gold threads 215 can be configured in an arrangement that is sufficiently discrete such that electrical current flow is limited to between an area on one side of the planar surface and an area on the opposite side of the planar surface. The gold threads 215 are arranged such that electrical current from an area of one side of the planar surface will only pass through the gold threads 215 to the area of the surface directly opposite of the first side rather than the electrical current flowing throughout the conductive membrane 210. In other embodiments, the conductive membrane 210 can comprise conductive carbon filaments, metal encapsulated plastics (anisotropic conductive types), platinum threads, metal alloy of nickel and titanium (nitinol), other surgically allowed metals, noble metals, surgical steel.

In the embodiments depicted in FIG. 2M, the base contacts 130 and the adaptor contacts are configured to be raised from the respective contact surfaces 115, 165. A conducting film membrane 210 is interleaved between the base contacts 130 and the adaptor contacts 180. The variability in heights 200, 202 can be seen as well as the resulting variable contact spacing 205. FIG. 2N illustrates that as the base 110 and the adaptor 160 are brought in close proximity along the z-axis, they self-align along and then self-engage along the z-axis. The conductive membrane 210 provides a slip feature along the z-axis by deforming to overcome the variable contact spacing 205. The conductive membrane 210 deforms to fill any resulting variable contact spacing 205 between the base electrical contact 130 and the adaptor electrical contact 180. As the base electrical contact 130 and the adaptor electrical contact 180 contact opposite surfaces of the conductive membrane 210, the gold threads 215 of the conductive membrane 210 allow base electrical contact 130 and the adaptor electrical contact 180 to electrically connect. The anisotropic arrangement of the gold threads 215 permits only a pair of a corresponding base electrical contact 130 and an adaptor electrical contact 180 to directly electrically connect. The anisotropic arrangement of the gold threads 215 prevents adjacent base electrical contacts 130 and adaptor electrical contacts 180 from directly electrically connecting.

In some embodiments, the thickness of the conductive membrane 210 is configured to correspond to the heights 200, 202 and the corresponding variable contact spacing 205. The thickness of the conductive membrane 210 is configured such that, within the tolerances of manufacturing the corresponding components, it approximates the variable contact spacing 205. In other embodiments, the deformability of the conductive membrane 210, the density of gold threads 215, and the gauge of the gold threads 215 are configured to minimize the variable contact spacing 205 and/or to maximize electrical current flow between base 110 and adaptor 160.

In other embodiments, the z-axis slip compensating features that utilize a conductive membrane 210 can be configured to be used with matching pairs of base and adaptor magnets 120, 170. In yet other embodiments, the z-axis slip compensating features that utilizes a conductive membrane 210 can be configured to be used with integrated units of combination base magnets 120/base electrical contacts 130 and/or with integrated units of combination adaptor magnets 170/adaptor electrical contacts 180.

In operation, the base magnets 120 and the corresponding adaptor magnets 170 serve to self-align and self-engage the connector 10 and to enable electrical connection. The quantity, density, arrangement, and ratio of magnets 120, 170 to electrical contacts 130, 180 can be varied to manipulate the strength of the magnetic attraction between the base 110 and the adaptor 160. Likewise, the quantity, arrangement, and ratio of integrated combination magnet/contact units to electrical contacts 130, 180 can be varied to manipulate the strength of the magnetic attraction between the base 110 and the adaptor 160. A ratio of more magnets to electrical contacts results in a stronger magnetic attraction between base 110 and adaptor 160, while a ratio of less magnets to electrical contacts results in a weaker magnetic attraction between the base 110 and the adaptor 160. As well, the spacing between the magnets 120 on the base contact surface 115 can be increased or decreased to vary the magnetic attraction. The spacing between the magnets 170 on the base contact surface 165 can also be increased or decreased to vary the magnetic attraction.

In some embodiments, the strength of the magnetic attraction can be varied to allow for a breakaway configuration that allows for disconnection of the base 110 and the adaptor 160 when a force exerted between the base 110 and the adaptor 160 exceeds the threshold of the magnetic attraction. This breakaway configuration allows for the electrical connector 10 to self-disconnect, preventing injury or damage to the test subject, the implantable medical device 100, and/or the data acquisition system 150. The breakaway configuration is useful for a highly mobile or active test subject that might move beyond the extent of the adaptor interface or any tether system. Rather than the test subject being injured from possible jerking of the adaptor interface or any tether system, the breakaway configuration disconnects the connector 10. In some embodiments, the breakaway configuration avoids injury to the test subject, and damage or dislodging of the implantable medical device 100 is thereby avoided or minimized.

The strength of the magnetic attraction in the breakaway configuration can be adapted to the desired size and mobility of the test subject, as well as the nature and location of the implantable medical device 100. In some configurations, the breakaway configuration can allow for self-disconnection of the base 110 and the adaptor 160 when a force exerted between the base 110 and the adaptor 160 can be greater than a force equivalent to the body weight of a test subject. In other embodiments, the force can be greater than a force equivalent to 1% of the body weight of a test subject. In yet other embodiments, the force can be greater than a force equivalent to 50% of the body weight of a test subject. In some embodiments, the force can be greater than a force equivalent to 100% of the body weight of a test subject. In other embodiments, the force can be greater than a force equivalent to 200% of the body weight of a test subject. In yet other embodiments, the force can be greater than a force equivalent to 400% of the body weight of a test subject. In some embodiments, the force can be greater than a force equivalent to 1, 2, 5, 10, 15, 20, 25, 30, 35, 40, 45, 50, 55, 60, 65, 70, 75, 80, 85, 90, 95, or 100% of the body weight of a test subject. In other embodiments, the force can be greater than a force equivalent to 125, 150, 175, 200, 225, 250, 275, 300, 325, 350, 375, or 400% of the body weight of a test subject. In yet other embodiments, the test subject can be a rodent and the force can be greater than a force equivalent to between about 50% and 400% of the body weight of the rodent. In some embodiments, the test subject can be a human and the force can be greater than a force equivalent to between about 1% and 50% of the body weight of the human.

The breakaway configuration can also be configured to allow a different threshold of force for a lateral disconnection of the connector 10 as compared to a straight-on disconnection. A lateral disconnection refers to the base contact surface 115 and the adaptor contact surface 165 sliding with respect to each other substantially along the planes of the contact surfaces 115, 165 (along the x and y axes). A straight-on disconnection refers to a disconnection in which the base contact surface 115 and the adaptor contact surface 165 are disconnected by moving the contact surfaces 115, 165 substantially perpendicular to one another (along the z-axis). The threshold of force for a lateral disconnection can be greater than, the same as, or different than a straight-on disconnection.

In some configurations, the contact surfaces 115, 165 can incorporate ridges, knurled edges or other structures to aid the break-away configuration to allow for self-disconnection. As well, the connector 10 can contain a quick-release mechanism to allow for easy disconnection of the connector 10. The quick-release mechanism can comprise a wedge that is activated to disconnect the base 110 and the adaptor 160 by forcing the base 110 and the adaptor 160 apart. The quick-release mechanism can also contain a mechanism that is rotated to disconnect the connector 10.

The electrical connector 10 can also comprise a locking mechanism. The locking mechanism can allow an operation (i.e., a researcher) to lock the connector 10 to defeat the breakaway configuration. The locking mechanism can also be unlocked to activate the breakaway configuration.

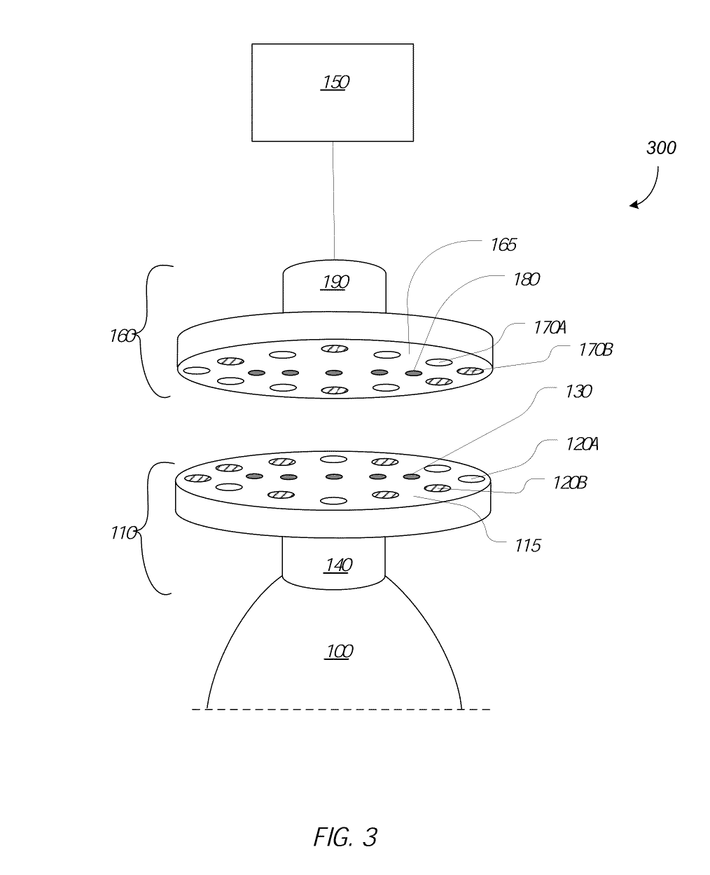

FIG. 3 illustrates an electrical connector system 300 for conducting a neurological study. The electrical connector system 300 comprises an implantable medical device 100, a data acquisition system 150, a base 110, and an adaptor 160. The implantable medical device 100 is configured to detect neurological activity of a test subject. The data acquisition system 150 is configured to capture, process, and/or analyze the detected neurological activity. The base 110 and the adaptor 160 function as a connector to allow signals corresponding to detected neurological activity to pass from the implantable medical device 100 to the data acquisition system 150.

The base 110 is attached to the implantable medical device 100 through a base interface 140. The base interface 140 is also configured to electrically connect the plurality of base electrical contacts 130 to the implantable medical device 100. The base 110 also includes a base contact surface 115 and a plurality of base magnets 120A and 120B. The plurality of base magnets 120A and 120B are arranged on the base contact surface 115 such that the polarities of the plurality of the base magnets 120A and 120B form a unique non-symmetrical pattern. In this example, base magnets 120A are arranged such that the magnetic north polarities are exposed on the base contact surface 115. Base magnets 120B are arranged such that the magnetic south polarities are exposed on the base contact surface 115. The base 110 further comprises a plurality of base electrical contacts 130. The base electrical contacts 130 are arranged on the base contact surface 115. In some embodiments, the base magnets 120 can also be configured as base electrical contacts 130.

In FIG. 3, the adaptor 160 further comprises an adaptor contact surface 165 that is configured to mate with the base contact surface 115. The adaptor 160 also comprises a plurality of adaptor magnets 170A and 170B. The plurality of adaptor magnets 170A and 170B are arranged on the adaptor contact surface 165 such that the polarities of the plurality of adaptor magnets 170A and 170B mirror the unique non-symmetrical pattern of the polarities of the base magnets 120A and 120B. As described in above, the polarities of the magnets 120A, 120B, 170A, 170B are arranged in a unique non-symmetrical pattern such that there is only one unique orientation in which the base 110 and the adaptor 160 can mate that is consistent with all of the magnetic attractions between the respective magnets 120A to 170B and 120B to 170A. Due to the unique non-symmetrical pattern of the polarities of the magnets, the base 110 and the adaptor 160 self-align in the x, y, and z axes and also through a rotational theta axis. Once the base 110 and adaptor 160 have self-aligned into the one unique orientation, the magnetic attraction of the paired polarities of the magnets 120A, 120B, 170A, 170B draws the base 110 and the adaptor 160 together to mate the base contact surface 115 and the adaptor contact surface 165 to self-engage the connector.

The adaptor 160 further comprises a plurality of adaptor electrical contacts 180 that are arranged on the adaptor contact surface 165 to mate with the base electrical contacts 130. When the base 110 and the adaptor 160 mate, the base electrical contacts 130 contact the adaptor electrical contacts 180 such that individual electrical connections are established between the base electrical contacts 130 and the adaptor electrical contacts 180. Each individual base electrical contact 130 is assured to establish an electrical connection with its respective partner adaptor electrical contact 180 because the base 110 and adaptor self-align and self-engage in the one unique orientation. In some embodiments, the adaptor magnets 170 can also be configured as adaptor electrical contacts 180. The adaptor 160 further comprises an adaptor interface 190 that is configured to electrically connect the plurality of adaptor electrical contacts 180 to the data processing unit 150.

In some embodiments, the implantable medical device 100 can comprise a sensing or stimulating implanted device, microelectrode array, CerePort Array, NeuroPort Array, Omnetics Array, ICS-96 Array, UEA, ECOG, ATLASNeuro Probe, micro-ECOGs, implanted electrodes with embedded data acquisition, light stimulation, and electrical stimulation and/or drug delivery systems. In other embodiments, the data acquisition system 150 can comprise a patient cable, data visualization for Cerebus, NeuroPort, CerePlexE, Digital Lynx 16SX, Digital Lynx SX-M, Digital Lynx 4SX, NSP, CereplexA, CerePlexM, and/or other similar devices and systems. In yet other embodiments, the system 150 can comprise stimulation or delivery systems. In some embodiments, the system 150 can comprise stimulation or delivery systems configured to stimulate or deliver via light, chemical means, sound waves, electrical signals, and/or magnetic signals.

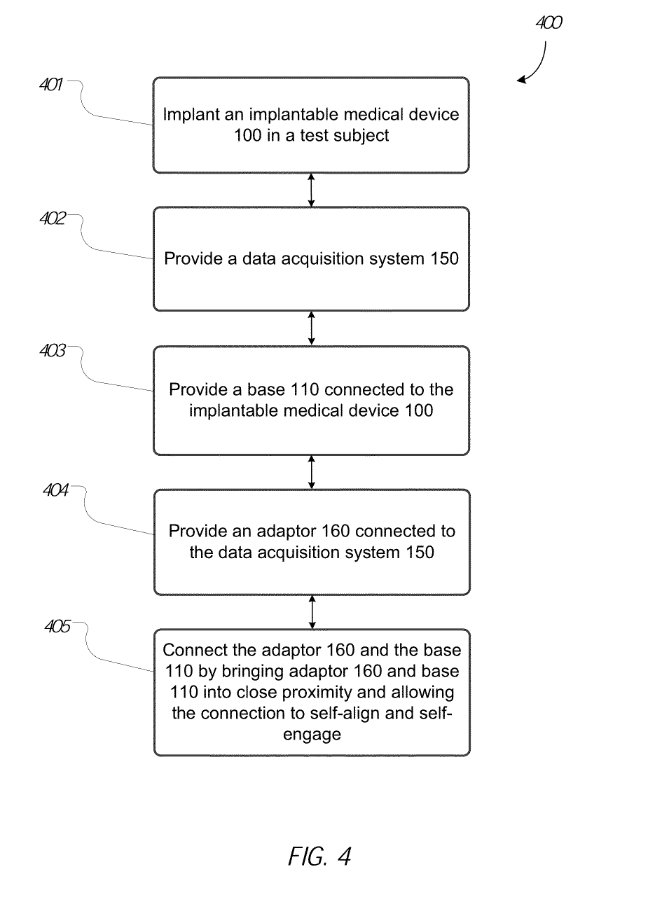

FIG. 4 illustrates a method 400 for conducting a neurological study. In method 400 the neurological study can include studies of extracellular neural recordings (spikes, field potentials), stimulation applications, optogenetics, acoustics, drug delivery, and/or magnetic stimulation. The method 400 includes implanting an implantable medical device in a test subject, as shown in box 401. The implantable medical device 100 can include any of the devices described above and the test subject can include humans, non-human primates, mice, rats, or any other suitable laboratory animals and/or cell cultures. The implantable medical device 100 can be implanted surgically. In some embodiments, the implantable medical device 100 can be implanted by a surgeon or by a trained technician.

The method also includes providing a data acquisition system 150, as shown in box 402. The data acquisition system 150 can include any of the systems described herein, as well as any other data acquisition system.

As shown in box 403, the base 110 is provided and connected to the medical device 100. In this process, the base 110 can be configured as described above and includes a base contact surface 115, the base magnets 120 are arranged on the base contact surface 115 so that the polarities of the base magnets 120 form a unique non-symmetrical pattern, the base electrical contacts 130 are arranged on the base contact surface 115 with one or more of the base magnets 120 further configured as base electrical contacts 130, and then the base interface 140 is configured to electrically connect the plurality of base electrical contacts 130 to the implantable medical device 100.

As shown in box 404, the adaptor 160 is provided and connected to the data acquisition system. In this process, the adaptor 160 includes an adaptor contact surface 165, the adaptor contact surface 165 configured to mate with the base contact surface 115, the adaptor magnets 170 are arranged on the adaptor contact surface 165 so that the polarities of the adaptor magnets 170 mirror the pattern of the polarities of the base magnets 120, the adaptor electrical contacts 130 are arranged on the adaptor contact surface 165 to mate with the base electrical contacts 130, with one or more of the adaptor magnets 170 further configured as adaptor electrical contacts 180, and the adaptor interface 190 is configured to electrically connect the adaptor electrical contacts 180 to the data acquisition system 150.

As shown in box 405 of method 400, the adaptor 160 and the base 110 are then connected by bringing the base contact surface 115 and the adaptor contact surface 165 into close proximity allowing the base 110 and the adaptor 160 to self-align. The unique non-symmetrical pattern of polarities cause the respective attractive and repulsive magnetic forces of the magnets 120, 170 to self-align the base 110 and the adaptor 160 with respect to each other along the x, y, and z axes and also through a rotational theta axis. Once the base 110 and adaptor 160 have self-aligned, the magnetic attraction of the paired polarities of the magnets (120A to 170B, and 120B to 170A) draws the base 110 and the adaptor 160 together to mate the base contact surface 115 and the adaptor contact surface 165, thereby self-engaging the connector. With the connection established, the electrical connection between the base electrical contacts 130 and the adaptor electrical contacts 180 is completed and the signals representing the detected neurological activity can be processed by the data acquisition system 150.

The self-aligning and self-engaging electrical connector can have several useful features. First, the electrical connector allows for a connection to be made without the need for any force to be exerted to mate the connectors because of the self-engaging configuration of the connector. The self-engaging feature also allows for the connector to be engaged by simply bringing the base 110 and the adaptor 160 into close proximity. The paired base magnets 120 and adaptor magnets 170 exert an attractive magnetic force to draw the contact surfaces 115, 165 of the base 110 and adaptor 160 together and cause the contact surfaces 115, 165 to contact, thereby self-engaging the connector. An operator does not need to exert any force to engage the base 110 and the adaptor 160, nor does the operator need to take any additional steps to further secure the connector after it has self-engaged. This self-engaging function allows for the connection to be made rapidly while minimizing injury to the test subject, damage to the implantable medical device 100, and frustration to the operator.

Second, the self-aligning configuration of the connector enables the operator to easily connect the implantable medical device 100 of a mobile, wiggling test subject to a data acquisition system 150. The self-aligning configuration of the connector enables the base 110 and the adaptor 160 to quickly self-align as the connection is being made. This reduces the amount of time that the test subject must be restrained to ensure proper alignment, also reducing the amount of stress and possibility of injury to the test subject and reducing the frustration of the operator who often suffers from reduced dexterity due to wearing gloves, and/or other protective gear and can often be subject to low light conditions or reduced visibility conditions.

Third, the breakaway configuration allows for the connector to self-disconnect when a certain threshold of force on the base 110 and the adaptor 160 has been reached. This breakaway configuration allows for the connector to self-disconnect, preventing injury or damage to the test subject, the implantable medical device 100, and/or the data acquisition system 150. This breakaway configuration is useful for a highly mobile or active test subject that might move beyond what the extent of the adaptor interface 190 or any tether system may allow. Rather than the test subject being injured from possible jerking of the adaptor interface 190 or any tether system, the breakaway configuration disconnects the connector. Injury to the test subject, and damage or dislodging of the implantable medical device 100 is avoided. The strength of the magnetic attraction in the breakaway configuration can be adapted to the size and mobility of the test subject and the nature and location of the implantable medical device 100.

In addition to any previously indicated modification, numerous other variations and alternative arrangements may be devised by those skilled in the art without departing from the spirit and scope of this description. The appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

We claim:

1. An electrical connector, comprising:
a base comprising base magnets with both positive and negative polarities; and
an adaptor comprising adaptor magnets configured to match with the base magnets, wherein each adaptor magnet has a polarity opposite to the polarity of the matching base magnet;
wherein the base magnets and the matching adaptor magnets self-align and self-engage the base and the adaptor to connect base electrical contacts with matching adaptor electrical contacts, and
wherein one or more of the base magnets are configured to operate as a base electrical contact and a matching adaptor magnet is configured to operate as an adaptor electrical contact.

2. The electrical connector of claim 1, wherein the base magnets are configured with respect to each other in a unique non-symmetrical pattern, the pattern configured to allow the base and the adaptor to self-align and self-engage.

3. The electrical connector of claim 1, wherein one or more of the base or adaptor magnets comprise transition metals, rare-earth elements, lanthanide elements and combinations thereof.

4. The electrical connector of claim 1, wherein one or more of the base or adaptor magnets comprise neodymium magnets.

5. The electrical connector of claim 1, further comprising a slip compensating feature configured to compensate for slip of either the base or the adaptor along the z-axis.

6. The electrical connector of claim 5, wherein one or more of the base magnets or adaptor magnets are raised relative to the base or adaptor, wherein the matching one or more adaptor magnets or base magnets are recessed relative to the base or adaptor, and wherein the one or more raised base magnets or adaptor magnets is configured to mate with the matching one or more adaptor magnets or adaptor magnets.

7. The electrical connector of claim 5, wherein one or more of the base magnets configured to operate as a base electrical contact is disposed within a recess in the base, the base magnet further comprising a conductive wire configured to bias the base magnet along the z-axis to overcome a variable contact spacing between the base magnet and a matching adaptor magnet.

8. The electrical connector of claim 5, wherein the slip compensating feature further comprises an anisotropically conductive membrane disposed between the base and the adaptor, the anisotropically conductive membrane configured to deform to overcome a variable contact spacing between base electrical contacts and adaptor electrical contacts.

9. The electrical connector of claim 1, further comprising a breakaway configuration configured to disengage the base and the adaptor when a threshold of force is applied to either the base or the adaptor.

10. The electrical connector of claim 9, wherein the threshold of force is adjusted between a minimum and maximum threshold by optimizing a ratio of base magnets to base electrical contacts.

11. A connection system, comprising:
a first connector containing first connecting elements with both positive and negative polarities;
a second connector containing second connecting elements configured to match with the first connection elements, wherein each second connecting element has a polarity opposite the matching first connecting element; and
a slip compensation feature located between the first and second connectors and configured to reduce or prevent a variable contact spacing between first connecting elements and second connecting elements along the z-axis;
wherein the first or second connector contains a geometrical feature configured to retain the slip compensation feature.

12. The system of claim 11, wherein one or more of the first or second connecting elements comprise magnets.

13. The system of claim 12, wherein the magnets comprise transition metals, rare-earth elements, lanthanide elements and combinations thereof.

14. The system of claim 11, wherein one or more of the first connecting elements or second connecting elements are raised relative to the first connector or second connector, wherein the one or more matching second connecting elements or first connecting elements are recessed relative to the first connector or the second connector, and wherein the one or more raised first connecting elements or second connecting elements is configured to mate with the one or more matching second connecting elements or first connecting elements.

15. The system of claim 11, wherein one or more of the first connecting elements is disposed within a recess in the first connector, the first connecting element further comprising a conductive wire configured to bias the first connecting element along the z-axis to overcome the variable contact spacing.

16. The system of claim 11, wherein the slip compensating feature further comprises an anisotropically conductive membrane disposed between the first connector and the second connector, the anisotropically conductive membrane configured to deform to overcome the variable contact spacing.

17. The system of claim 11, further comprising a breakaway configuration configured to disengage the first connector and the second connector when a threshold of force is applied to either the first connector or the second connector.

18. The system of claim 17, wherein one or more of the first or second connecting elements comprise magnets and the threshold of force is adjusted between a minimum and maximum threshold by decreasing or increasing a total of magnets used.

19. The system of claim 11, further comprising an implantable medical device electrically connected to the first connector and a data acquisition system electrically connected to the second connector.

20. An electrical connector, comprising:
a base comprising base magnets with both positive and negative polarities, the base magnets arranged such that the polarities of the base magnets form a non-symmetrical pattern; and
an adaptor comprising adaptor magnets that are configured to match with the base magnets, wherein each adaptor magnet has a polarity opposite to the polarity of the matching base magnet; and
wherein the non-symmetrical pattern self-aligns the base and the adaptor and the base magnets and the matching adaptor magnets self-engage the base and the adaptor, thereby connecting base electrical contacts with matching adaptor electrical contacts;
wherein one or more of the base magnets are configured as base electrical contacts and the matching adaptor magnets are configured as adaptor electrical contacts.
